(19) United States
(12) Patent Application Publication
(10) Pub. No.: US 2014/0104559 A1
(43) Pub. Date: Apr. 17, 2014

(54) DISPLAY PANEL AND METHOD OF INSPECTING CURED STATE OF SEALING MATERIAL BASED ON FOURIER TRANSFORM INFRARED SPECTROSCOPY

(71) Applicant: Takafumi Hayama, Osaka-shi (JP)

(72) Inventor: Takafumi Hayama, Osaka-shi (JP)

(73) Assignee: SHARP KABUSHIKI KAISHA, Osaka-shi, Osaka (JP)

(21) Appl. No.: 14/123,380

(22) PCT Filed: May 29, 2012
(86) PCT No.: PCT/JP2012/063704

§ 371 Date: Dec. 2, 2013

(30) Foreign Application Priority Data
Jun. 3, 2011 (JP) 2011-125323

(51) Int. Cl. G02F 1/1339

(52) U.S. Cl. CPC G02F 1/1339
USPC 349/153; 445/3

(57) ABSTRACT

A display panel (100A) according to an embodiment of the present invention includes a first substrate (12) having an end region (12p) and a pixel formation region (12D), a second substrate (22) arranged so as to face the first substrate (12) and expose the end region (12p) of the first substrate (12), a display medium layer (32) arranged between the first substrate (12) and the second substrate (22), a sealing portion (42a) configured to bond the first substrate (12) to the second substrate (22) and surround the pixel formation region (12D), and an additional sealing portion (44a) arranged in the end region (12p) of the first substrate (12), the additional sealing portion (44a) being composed of the same material as that of the sealing portion (42a), in which the first substrate (12) further includes a metal layer (14a) below the additional sealing portion (44a). In the display panel (100A), it is possible to evaluate the cured state of the sealing material of the additional sealing portion (44a) by Fourier transform infrared spectroscopy.

### TECHNICAL FIELD

The present invention relates to a display panel and a method of inspecting the cured state of a sealing material in a process for producing a display panel.

### BACKGROUND ART

In recent years, flat panel displays, such as liquid crystal displays, have been widely used. Typically, display panels of flat panel displays each have a display medium between a pair of substrates. The pair of substrates is bonded together with a curable resin, called a sealing material. A display medium (for example, a liquid crystal layer or an electrophoretic layer) is hermetically sealed and held in a gap between the pair of substrates. An organic electroluminescent (EL) display panel has a structure in which an elemental portion including an organic EL layer is hermetically sealed in a gap between a pair of substrates and is thus protected from an environment.

In these display panels, insufficient curing of the sealing materials may lead to reductions in display quality and reliability.

A problem attributed to the curing failure of a sealing material in a conventional liquid crystal display panel 200 will be described with reference to (a) and (b) of FIG. 7.

The liquid crystal display panel 200 includes, for example, a thin-film transistor (TFT) substrate 12, a counter substrate 22, and a liquid crystal layer 32 arranged between the TFT substrate 12 and the counter substrate 22. The TFT substrate 12 and the counter substrate 22 are bonded together with a sealing portion 42 formed by curing a sealing material. The sealing portion 42 is arranged so as to substantially surround the liquid crystal layer 32.

The sealing material contains a photocurable resin (for example, an ultraviolet curable acrylic resin) and, if necessary, a filler, a granular spacer, and/or conductive grains. For example, the sealing material is disposed on the TFT substrate 12 with a dispenser to form a predetermined pattern. In the case where a liquid crystal material is injected by a drop injection method, the sealing material is disposed on the TFT substrate 12 so as to completely surround a pixel formation region 12D of the TFT substrate 12 (a region of the TFT substrate to be formed into a display region 10D of a liquid crystal display panel). In the case where a liquid crystal material is injected by a vacuum injection method, the sealing material is disposed on the TFT substrate 12 so as to form an injection hole. The TFT substrate 12 and the counter substrate 22 are bonded together. The sealing material is cured. The liquid crystal material is injected into a gap between the TFT substrate 12 and the counter substrate 22. Then the injection hole is filled with a sealing resin. In this specification, the sealing portion of the liquid crystal display panel includes not only a portion formed with the sealing material but also a portion which is composed of the sealing resin and which is configured to block the injection hole.

In the region of the TFT substrate 12, a region facing the counter substrate 22 (including the pixel formation region 12D) is referred to as a facing region 12c, and a region which does not face the counter substrate 22 and at which is exposed is referred to as an end region 12p. For example, a terminal region 13 is formed in the end region 12p of the TFT substrate 12. For example, a driving integrated circuit (IC) is mounted on the terminal region 13. The designations of the regions are also used in the description of the present invention.

A liquid crystal display panel in which the injection of a liquid crystal material is performed by a drop injection method is taken as an example, and problems of the related art will be described below. In the drop injection method, failure attributed to a sealing material is liable to occur, compared with the vacuum injection method. Two main reasons for this will be described below.

(1) The sealing material comes into contact with the liquid crystal material before the sealing material is cured. Thus, impurities from the sealing material are liable to be eluted in the liquid crystal material. (2) The sealing material is cured after the injection of the liquid crystal material. It is difficult to sufficiently set curing conditions of the sealing material on the safe side (for example, the amount of ultraviolet radiation is sufficiently increased).

In the liquid crystal display panel 200, insufficient curing of the sealing material included in the sealing portion 42 may cause display unevenness. Specifically, as illustrated in FIG. 7(b), a defective display region 10p (for example, a low-luminance region) is observed in the vicinity of the sealing portion 42 in the display region 10D. The reason for this is presumably that an uncured component in the sealing material is eluted in the liquid crystal material and that a voltage effectively applied to a liquid crystal layer is reduced by, for example, interfacial polarization attributed to an ionic impurity. The ionic impurity diffuses with time to extend the defective display region 10p.

Currently, in the process for producing a display panel, the cured state of a sealing material is not directly inspected. Display unevenness is visually observed in the dynamic operating inspection of the display panel. That is, in the case where the display unevenness is observed in the dynamic operating inspection, information that display unevenness occurred is transmitted during a step of bonding substrates (including a substep of curing a sealing material), and, for example, curing conditions of the sealing material are changed.

In the current process, it takes some time to feed back the results of the dynamic operating inspection to the step of bonding the substrates after the completion of the bonding. This may cause a problem in which substrates are subjected to the bonding step under prior curing conditions before, for example, the curing conditions of the sealing material are changed on the basis of the feedback information. It is thus preferred to directly inspect the cured state of the sealing material before the dynamic operating inspection of the display panel.

However, such a method is not reported. For example, PTL 1 discloses a method of optically inspecting a pattern of a sealing material arranged on a substrate. In this method, however, the cured state of sealing material cannot be inspected.

### CITATION LIST

### Patent Literature

PTL 1: Japanese Unexamined Patent Application Publication No. 10-170242

### SUMMARY OF INVENTION

### Technical Problem

The present invention has been accomplished in order to enable the direct inspection of the cured state of a sealing material before the dynamic operating inspection of a display panel. Specifically, the present invention aims to provide a method of nondestructively inspecting the cured state of a sealing material, the method being easily employed for a process for mass production of a display panel, and a display panel configured to enable the inspection to be performed.

### Solution to Problem

A display panel according to an embodiment of the present invention includes a first substrate having an end region and a pixel formation region; a second substrate arranged so as to face the first substrate and expose the end region of the first substrate; a display medium layer arranged between the first substrate and the second substrate; a sealing portion configured to bond the first substrate to the second substrate and surround the pixel formation region; and an additional sealing portion arranged in the end region of the first substrate, the additional sealing portion being composed of the same material as that of the sealing portion, in which the first substrate further includes a metal layer below the additional sealing portion.

In an embodiment, the first substrate includes a plurality of lines and a plurality of electrodes, and the metal layer is separated from the plurality of lines and the plurality of electrodes.

In an embodiment, the metal layer is composed of the same material as that of any of the plurality of lines and the plurality of electrodes.

In an embodiment, the additional sealing portion is in direct contact with the metal layer.

In an embodiment, the sealing portion is composed of an ultraviolet-curable acrylic resin.

A method of inspecting the cured state of a sealing material according to an embodiment of the present invention by Fourier transform infrared spectroscopy in a process for producing any of the display panels described above, the process including a step of forming the sealing portion and the additional sealing portion by curing the sealing material, includes after the step of forming the sealing portion and the additional sealing portion, step a of acquiring the infrared reflection-absorption spectrum of the additional sealing portion from the second substrate side with the metal layer; and step b of evaluating the cured state of the sealing material on the basis of the resulting infrared reflection-absorption spectrum of the additional sealing portion.

In an embodiment, step b includes substep b1 of comparing the previously provided infrared reflection-absorption spectrum of the sealing material in a good cured state with the infrared reflection-absorption spectrum of the additional sealing portion.

### Advantageous Effects of Invention

According to embodiments of the present invention, a display panel and a method of inspecting the cured state of a sealing material are provided, in which the display panel and the method enable the direct inspection of the cured state of the sealing material at the earliest possible stage before the dynamic operating inspection of the display panel.

### BRIEF DESCRIPTION OF DRAWINGS

[FIG. 1] (a) and (b) schematically illustrate the structure of a liquid crystal display panel 100A according to an embodiment of the present invention, in which (a) is a schematic plan view of the liquid crystal display panel 100A, and (b) is a schematic cross-sectional view of the liquid crystal display panel 100A in the vicinity of an end region 12p.

[FIG. 2] (a) and (b) are schematic drawings illustrating the structure of an apparatus for acquiring an infrared reflection-absorption spectrum of an additional sealing portion.

[FIG. 3] (a) and (b) illustrate the infrared reflection-absorption spectrum (OK) of a sealing material in a good cured state and the infrared reflection-absorption spectrum (NG) of a sealing material in a poor cured state.

FIG. 4 illustrates another method of quantitatively determining a cured state, regarding the infrared reflection-absorption spectrum (NG) in a poor cured state and the infrared reflection-absorption spectrum (OK) of a sealing material in a good cured state.

FIG. 5 illustrates infrared reflection-absorption spectra of a cured grease-contaminated sealing material (NG), a good cured state (OK) free from an impurity, and grease (impurity) with which a sealing material is contaminated.

[FIG. 6] (a) to (c) are schematic plan views of liquid crystal display panels 100B, 100C, and 100D according to other embodiments of the present invention.

[FIG. 7] (a) and (b) illustrates problems with the conventional liquid crystal display panel 200, the problems being attributed to curing failure of a sealing material.

### DESCRIPTION OF EMBODIMENTS

A display panel according to an embodiment of the present invention and a method of inspecting the cured state of a sealing material in a production process of the display panel will be described below with reference to the drawings. While a liquid crystal display panel and a production process therefor are illustrated below, the present invention is not limited to embodiments illustrated.

(a) and (b) of FIG. 1 schematically illustrate the structure of the liquid crystal display panel 100A according to an embodiment of the present invention. FIG. 1(a) is a schematic plan view of the liquid crystal display panel 100A. FIG. 1(b) is a schematic cross-sectional view of the liquid crystal display panel 100A in the vicinity of the end region 12p.

The liquid crystal display panel 100A includes a first substrate 12, a second substrate 22, and a display medium layer 32 arranged between the first substrate 12 and the second substrate 22. Here, the first substrate 12 represents a TFT substrate 12. The second substrate 22 represents a counter substrate 22. The display medium layer 32 represents a liquid crystal layer 32. Each of the TFT substrate 12 and the counter substrate 22 includes a glass substrate and a necessary component arranged on the glass substrate. The TFT substrate 12 includes a plurality of TFTs, a plurality of lines, and a plurality of pixel electrodes, the plural lines and the plural pixel electrodes being connected to the plural TFTs. The counter substrate includes a color filter layer and a black matrix (light-shielding layer). These structures are well known, so descriptions thereof are omitted.

The TFT substrate 12 includes the end region 12p and a pixel formation region 12D. A terminal region 13a is arranged in the end region 12p of the TFT substrate 12. The pixel formation region 12D is formed into a display region 10D of the liquid crystal display panel 100A. The counter substrate 22 is arranged so as to face a facing region 12c of the TFT substrate 12 and expose the end region 12p of the TFT substrate 12. The TFT substrate 12 and the counter substrate 22 are bonded to each other with a sealing portion 42a arranged so as to surround the pixel formation region 12D. The TFT substrate 12 further includes an additional sealing portion 44a in the end region 12p, the additional sealing portion 44a being composed of the same material as that of the sealing portion 42a; and a metal layer 14a arranged below the additional sealing portion 44a. The liquid crystal display panel 100A is a liquid crystal display panel produced by a drop injection method. The liquid crystal layer 32 is arranged in a region (display region 10D) surrounded by the sealing portion 42a.

As illustrated in FIG. 1(b), the metal layer 14a and the additional sealing portion 44a arranged on the metal layer 14a are located in the end region 12p of the TFT substrate 12. Thus, when the counter substrate 22 of the liquid crystal display panel 100A is irradiated with infrared radiation (IR), the infrared radiation is directly incident on the additional sealing portion 44a, passes through the additional sealing portion 44a, and then is reflected from the interface between the metal layer 14a and the additional sealing portion 44a, as indicated by a dashed arrow. The cured state of the sealing material constituting the additional sealing portion 44a may be inspected by the analysis of the absorption spectrum of the reflected infrared radiation. That is, the cured state of the sealing material constituting the additional sealing portion 44a may be inspected by what is called reflection Fourier transform infrared spectroscopy (FT-IR). The glass substrate included in the counter substrate 22 strongly absorbs infrared radiation. Thus, when infrared radiation passes through the glass substrate, the intensity of the infrared absorption spectrum is markedly reduced, thereby reducing the analytical precision. To prevent this, the additional sealing portion 44a is preferably arranged in a portion of the end region 12p where the counter substrate 22 is not present. The same is true in the case of using a plastic substrate in place of the glass substrate. The configuration of a spectrometer and so forth used for reflection FTIR will be described below.

The metal layer 14a may be composed of, for example, the same metal material as that constituting any of the plural lines (for example, a gate bus line and a source bus line) and the plural electrodes (for example, a gate electrode, a source electrode, and terminal electrodes thereof) included in the TFT substrate 12. The metal layer 14a is preferably separated from the lines and electrodes (including lines and electrodes in the terminal region 13a) included in the TFT substrate 12. The metal layer 14a is just covered with the additional sealing portion 44a and is not sufficiently insulated, in some cases. Thus, when the lines and so forth are connected to the metal layer 14a, the lines and so forth may not be sufficiently insulated.

Examples of a material contained in the metal layer 14a include tantalum (Ta), molybdenum (Mo), titanium (Ti), copper (Cu), and aluminum (Al). These metals have sufficiently high infrared reflectance. The metal layer 14a may have a single-layer structure or a multilayer structure. The metal layer 14a may be formed by the same process as that for the lines and so forth included in the TFT substrate 12. Thus, the metal layer 14a may be formed only by, for example, changing a mask pattern to form a line in the current production process. The thickness of the metal layer 14a is not particularly limited. In the case where the metal layer 14a is formed by the same process as that for the lines and so forth, the thickness thereof may be equal to that of the line or the like. The metal layer 14a has a thickness of, for example, 100 nm to 500 nm. The size of the metal layer 14a (size when viewed in the direction normal to the TFT substrate 12) is, for example, 50 μm×50 μm, depending on a detection optical system and a FT-IR spectrometer (the size of a detector), as described below.

Commonly, the lines and so forth are covered with insulating layers (for example, a gate insulating layer, a passivation layer, and/or an interlayer insulating layer). However, the metal layer 14a is preferably in direct with the additional sealing portion 44a. In the case where an insulating layer (for example, a SiNₓ layer, a SiO₂ layer, or an organic insulating layer) is present between the metal layer 14a and the additional sealing portion 44a, infrared radiation passes through the insulating layer. Thus, the infrared absorption spectrum of the insulating layer is superimposed on the infrared absorption spectrum of the additional sealing portion 44a. That is, the infrared absorption spectrum of the insulating layer acts as noise that interferes with the infrared absorption spectrum of the additional sealing portion 44a. Thus, the infrared absorption spectrum of the additional sealing portion 44a is not analyzed with high accuracy, in some cases. Therefore, the insulating layer formed after the formation of the metal layer 14a is preferably patterned so as to have, for example, an opening configured to expose the metal layer 14a. In the case where a natural oxide film is formed on a surface of the metal layer 14a, the natural oxide film does not have an adverse effect on the analysis of the infrared absorption spectrum of the additional sealing portion 44a if the natural oxide film is sufficiently thin. In the case where an alignment layer is formed on the TFT substrate 12, it is preferable not to form an alignment layer on the metal layer 14a.

The additional sealing portion 44a may be formed with the same sealing material and by the same process as those used for the sealing portion 42a. Typically, a sealing portion is formed by applying a sealing material to a predetermined position of a substrate with a dispenser or the like, bonding the substrate to another substrate, and curing the sealing material. As described above, the fact that the sealing material is continuously applied to the predetermined position on the substrate is also expressed as the fact that a seal pattern is drawn with the sealing material.

The sealing portion 42a and the additional sealing portion 44a are formed as described below, for example.

A seal pattern (to be formed into the sealing portion 42a) is drawn in the facing region 12c of the TFT substrate 12 including the metal layer 14a, the lines, and so forth so as to surround the pixel formation region 12D. This operation is successively performed before or after an operation described below. A seal pattern (including a portion to be formed into the additional sealing portion 44a) is drawn so as to cover the metal layer 14a in the end region 12p. While FIG. 1(a) illustrates an example of the sealing portion 42a connected to the additional sealing portion 44a, the present invention is not limited thereto. That is, the additional sealing portion 44a may be separated from the sealing portion 42a. However, the seal pattern is preferably continuous in such a manner that the amount of the sealing material ejected per unit time from the dispenser is constant (in such a manner that the width of the seal pattern is constant).

A liquid crystal material is dropped into the pixel formation region 12D of the TFT substrate 12 where the predetermined seal pattern has been drawn. After the TFT substrate 12 is bonded to the separately produced counter substrate 22, the sealing material containing, for example, an ultraviolet-curable acrylic resin is irradiated with a predetermined amount of ultraviolet radiation. Conversely, a liquid crystal material may be dropped into a region of the counter substrate 22 facing the pixel formation region 12D of the TFT substrate 12. The cured state of the additional sealing portion 44a is evaluated instead of evaluating the cured state of the sealing portion 42a. Thus, the additional sealing portion 44a is formed by the same process and under the same conditions as those for the sealing portion 42a.

Next, the infrared reflection-absorption spectrum of the additional sealing portion 44a is acquired from the counter substrate 22 side using the metal layer 14a. The cured state of the sealing material is evaluated on the basis of the resulting infrared reflection-absorption spectrum of the additional sealing portion 44a.

A method of acquiring the infrared reflection-absorption spectrum of the additional sealing portion 44a (not illustrated in FIG. 2) of the liquid crystal display panel 100A and a method of evaluating the cured state of the sealing material on the basis of the infrared reflection-absorption spectrum will be described below with reference to (a) and (b) of FIG. 2.

(a) and (b) of FIG. 2 are schematic drawings illustrating the structure of an apparatus for acquiring the infrared reflection-absorption spectrum of the additional sealing portion 44a. As schematically illustrated in FIG. 2(a), the infrared reflection-absorption spectrum of the additional sealing portion 44a of the liquid crystal display panel 100A is measured with a FT-IR spectrometer 51.

Infrared radiation emitted from the FT-IR spectrometer 51 converges on the metal layer 14a (see FIG. 2(b)) of the liquid crystal display panel 100A via a plane mirror 52, a concave mirror 53, a plane mirror 54, and a Cassegrain mirror 55. As schematically illustrated in FIG. 2(b), the Cassegrain mirror 55 includes a plurality of concave mirrors, a plane mirror, and an aperture and guides infrared radiation reflected off the metal layer 14a to a detector (for example, a mercury-cadmium-tellurium (MCT) detector) 51D of the FT-IR spectrometer 51. The use of the Cassegrain mirror 55 efficiently acquires a reflection infrared spectrum from a minute region. This method is also referred to as a “masking method”.

As the Cassegrain mirror 55, a Cassegrain mirror having a magnification of, for example, ×32 is used. The beam diameter of infrared radiation emitted from the FT-IR spectrometer 51 is, for example, about 7 to about 8 mm. The light-receiving surface of the detector 51D has an area of about 250 μm×250 μm. Here, in the case of using the Cassegrain mirror 55 having a magnification of ×32, infrared radiation reflected from the 46 μm×46 μm area of the metal layer 14a is incident on the entire light-receiving surface of the detector 51D. Thus, in this case, the metal layer 14a may have a size of about 50 μm×about 50 μm.

The infrared reflection-absorption spectrum acquired with the FT-IR spectrometer 51 is analyzed by a computer 56. The computer 56 is connected to a monitor 57, and a storage device 58. The infrared reflection-absorption spectrum is displayed on the monitor 57 and stored in the storage device 58. The cured state of the sealing material is evaluated by, for example, a comparison of a previously provided infrared absorption spectrum of the sealing material in a good cured state with the resulting infrared reflection-absorption spectrum of the additional sealing portion 44a. The infrared absorption spectrum of the sealing material in a good cured state is stored in the storage device 58 and compared with the resulting infrared reflection-absorption spectrum of the additional sealing portion 44a by the computer 56. The comparison results may be calculated by the computer 56 and, for example, expressed as the agreement rate of the resulting infrared reflection-absorption spectrum of the additional sealing portion 44a with respect to the infrared absorption spectrum of the sealing material in a good cured state. Alternatively, the resulting infrared reflection-absorption spectrum of the additional sealing portion 44a and the infrared absorption spectrum of the sealing material in a good cured state may be displayed on the monitor 57 and visually evaluated. Furthermore, a difference spectrum between the resulting infrared reflection-absorption spectrum of the additional sealing portion 44a and the infrared absorption spectrum of the sealing material in a good cured state may be determined and displayed by the computer 56.

Specific examples will be described below.

As the FT-IR spectrometer 51, Avatar 370 manufactured by Thermo Fisher Scientific K.K. was used. The detector 51D is an MCT detector having a light-receiving area of 250 μm×250 μm. The measurement wavelength range was set to the mid-infrared range (2.5 μm to 15 μm, wavenumber range: 4000 cm⁻¹ to 650 cm⁻¹). As is well known, vibrations of O—H, C—H, C═O, C═C, C—O, a benzene ring, and so forth appear as absorption peaks in this wavelength range. Measurement was performed at a resolution of 4 cm⁻¹, and the number of scans was 64 scans. The intensity of infrared radiation was 5 V or more on the basis of an interferogram.

The size of the metal layer 14a was 50 μm×50 μm. The Cassegrain mirror 55 having a magnification of ×32 was used. The metal layer 14a was composed of the same material (for example, titanium (Ti)) as that of a source bus line on the TFT substrate 12 and formed simultaneously with the source bus line. As a sealing material, an ultraviolet-curable acrylic resin (for example, model: SD-28, manufactured by SEKISUI CHEMICAL CO., LTD.) was used.

(a) and (b) of FIG. 3 illustrate the infrared reflection-absorption spectrum (OK) of a sealing material in a good cured state and the infrared reflection-absorption spectrum (NG) of a sealing material in a poor cured state.

As illustrated in FIG. 3(a), the spectra is substantially the same in the wavenumber range of 4000 cm⁻¹ to 650 cm⁻¹, regardless of whether the cured state is good (OK) or poor (NG), because the same acrylic resin (cured product) is used as a main component. In the case where attention is focused on the expanded wavenumber range of 900 cm⁻¹ to 740 cm⁻¹ as illustrated in FIG. 3(b), a difference between good (OK) and poor (NG) cured states is clearly observed. Characteristic absorption peak A appearing at about 810 cm⁻¹ is assigned to the C—H out-of-plane bending vibration in a vinyl group of the acrylate-based sealing material. In the ultraviolet-curable acrylic resin, free radicals generated from a polymerization initiator by irradiation with ultraviolet radiation initiate a chain polymerization reaction. In a curing reaction process, C═C bonds and out-of-plane C—H bonds are reduced. However, in the wavenumber range of about 1640 cm⁻¹ to about 1620 cm⁻¹ assigned to the C═C bond, an absorption peak attributed to a chemical bond formed by the polymerization reaction and absorption by water vapor in an atmosphere may be superimposed on the background. Thus, the absorption peak located at about 810 cm⁻¹ at which the change of the background is relatively small was selected as an index.

The agreement rate of the infrared reflection-absorption spectrum (NG) of the sealing material in a poor cured state illustrated here with respect to the infrared reflection-absorption spectrum (OK) of the sealing material in a good cured state was 91%. The agreement rate was determined by “OMNIC” software included with Avatar 370 manufactured by Thermo Fisher Scientific K.K. The wavenumber range used to determine the agreement rate was set from 4000 cm⁻¹ to 650 cm⁻¹. The wavenumber range (wavelength range) used to determine the agreement rate may be appropriately set, depending on the type of sealing material.

The quality of the effect state may be determined on the basis of the agreement rate. For example, the value of the agreement rate determined to be good may be set by, in advance, checking whether display unevenness occurs in samples having different cured states beforehand. For example, an agreement rate of 95% or more is determined to be good.

In the case of visually determining the quality of the cured state, the range of about 900 cm⁻¹ to about 740 cm⁻¹ may be expanded as illustrated in FIG. 3(b). Needless to say, the absorption peak (the wavenumber range on which attention is focused) may be appropriately changed, depending on the type of sealing material.

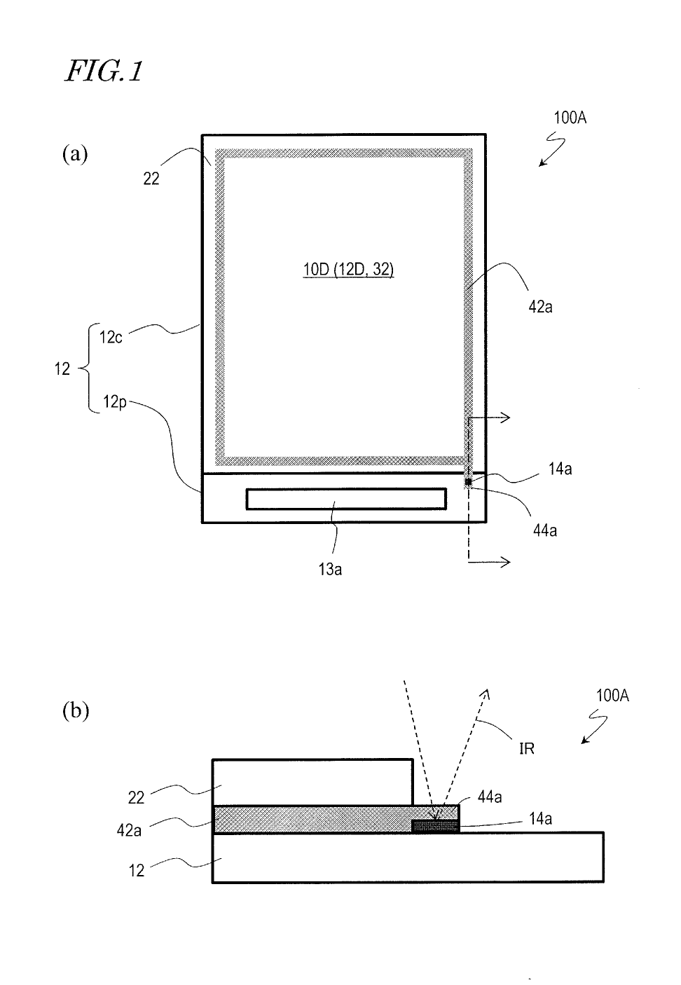

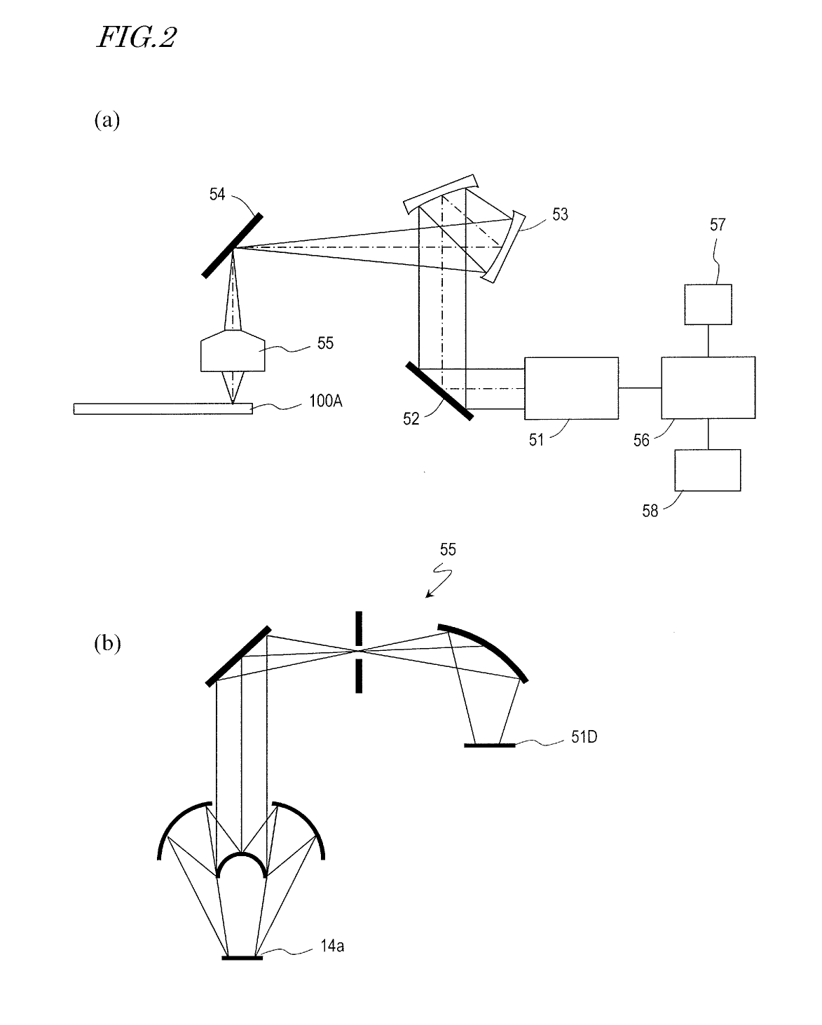

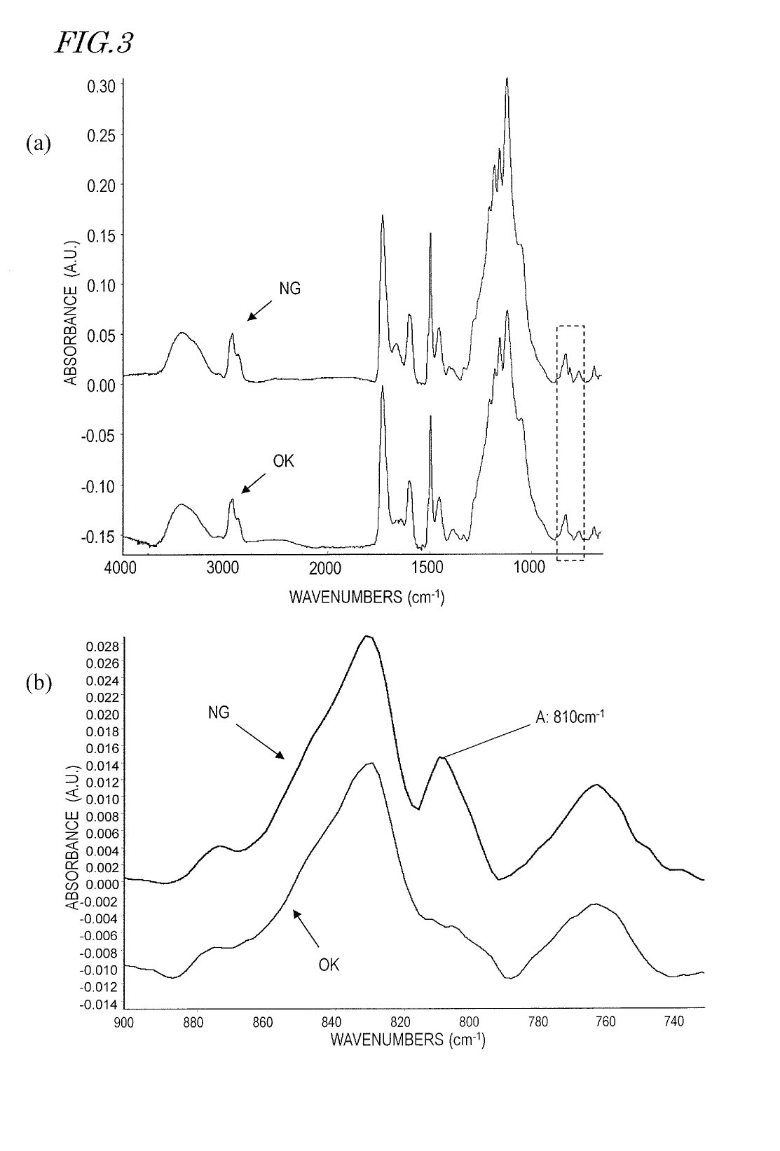

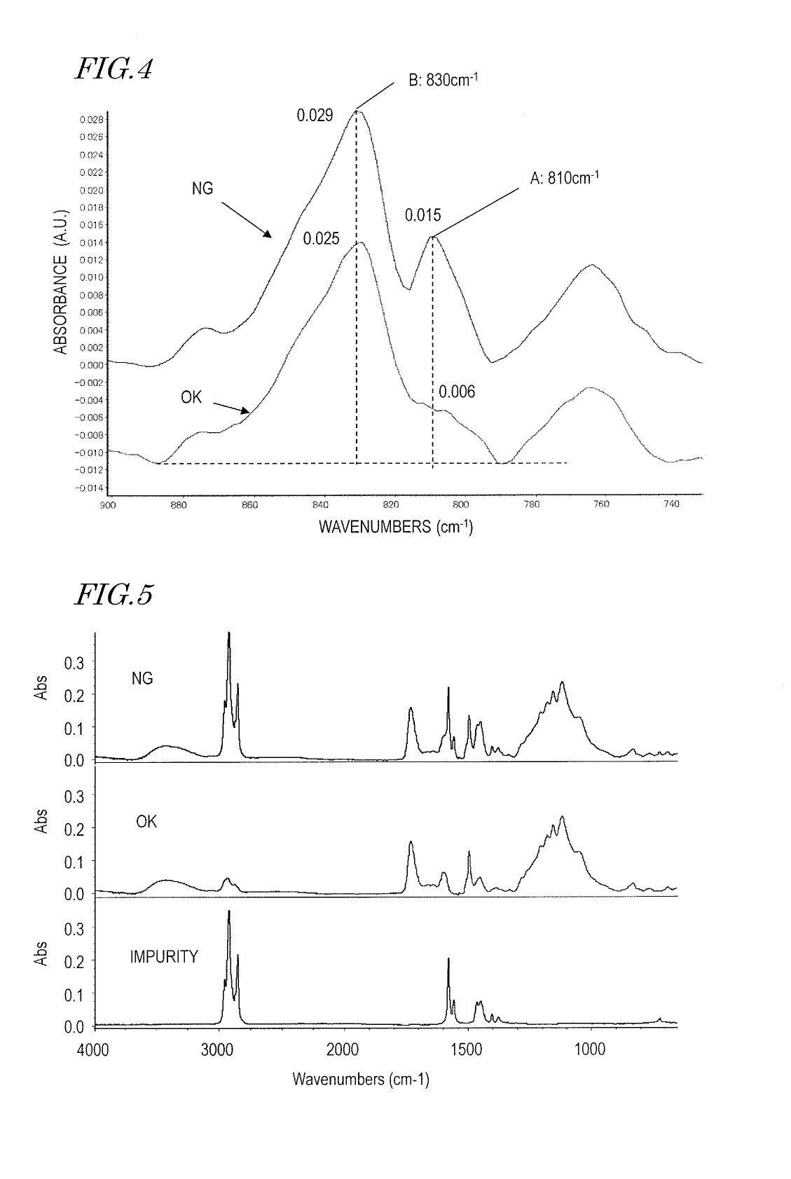

Regarding the infrared reflection-absorption spectrum (NG) in a poor cured state and the infrared reflection-absorption spectrum (OK) of a sealing material in a good cured state, another method of quantitatively determining a cured state will be described below with reference to FIG. 4.

As illustrated in FIG. 4, regarding absorption peak A: 810 cm⁻¹ (C—H out-of-plane bending vibration) and absorption peak B: 830 cm⁻¹ (out-of-plane bending vibration of a benzene ring), the absorption intensity is determined as the height of each peak from the baseline. The values (ratios) of the intensity of absorption peak A/the intensity of absorption peak B were 0.24 for the good cured state (OK) and 0.51 for the poor cured state (NG). The results demonstrate that curing proceeds as the value of the intensity of absorption peak A/the intensity of absorption peak B is closer to 0.24. For example, when the value is 0.26 or less, the cured state may be determined to be good.

As described above, according to the embodiments of the present invention, it is possible to nondestructively and rapidly determine whether the cured state of the sealing material is good or poor. That is, according to the embodiments of the present invention, it is possible to inspect the cured state of the sealing material immediately after the completion of a step of curing a sealing material (an ultraviolet irradiation step). When the cured state is determined to be poor, the article may be immediately returned to the step of curing a sealing material and subjected to additional curing treatment (additional ultraviolet irradiation). In the case where a non-defective product is provided by the additional curing treatment, the yield may be increased. In addition, it is possible to immediately change the curing conditions and so forth, thereby increasing the yield. Furthermore, the foregoing inspection method may be easily employed in a mass-production line and is easy to operate and maintain. Thus, the increase in yield sufficiently absorbs the costs of the installation, operation, and maintenance of an apparatus for the inspection.

When the sealing material is changed, the quality of the sealing material is determined by the dynamic operating inspection of the display panel in the related art. In contrast, the use of the method of inspecting a sealing material according to an embodiment of the present invention eliminates the need for that, and it is possible to efficiently determine optimal curing conditions and so forth.

By the method of inspecting a sealing material according to an embodiment of the present invention, it is possible to determine not only the quality of the cured state of the sealing material but also whether the sealing material is contaminated with an impurity.

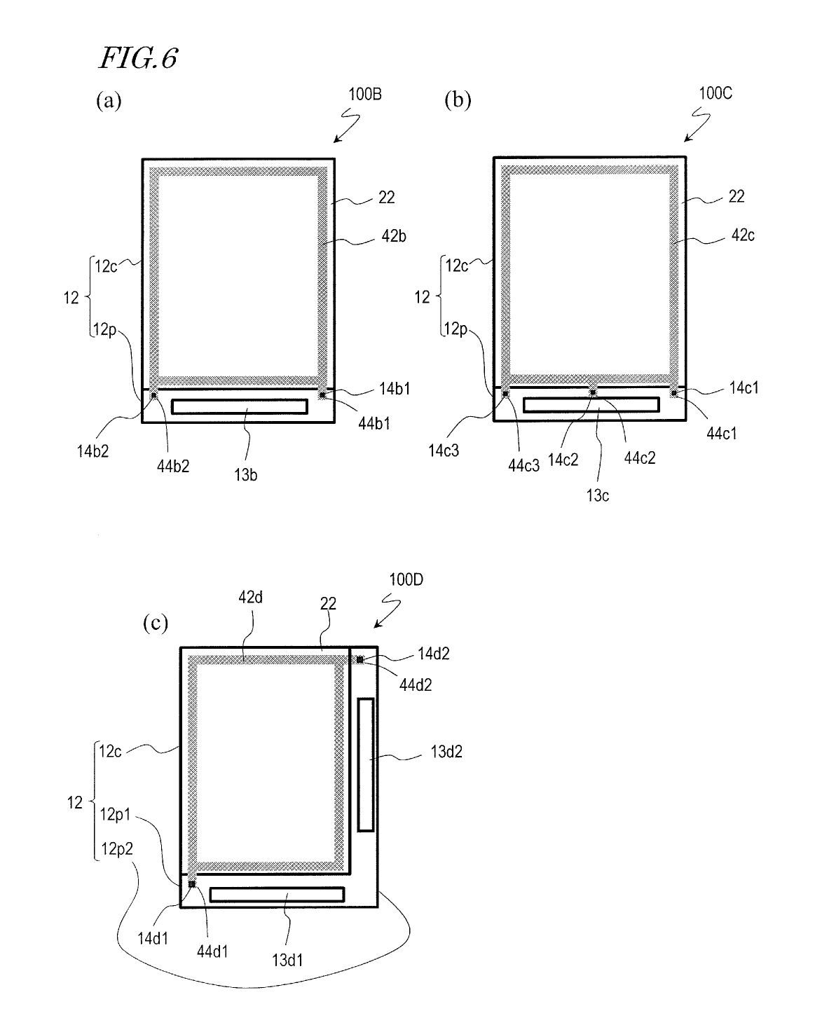

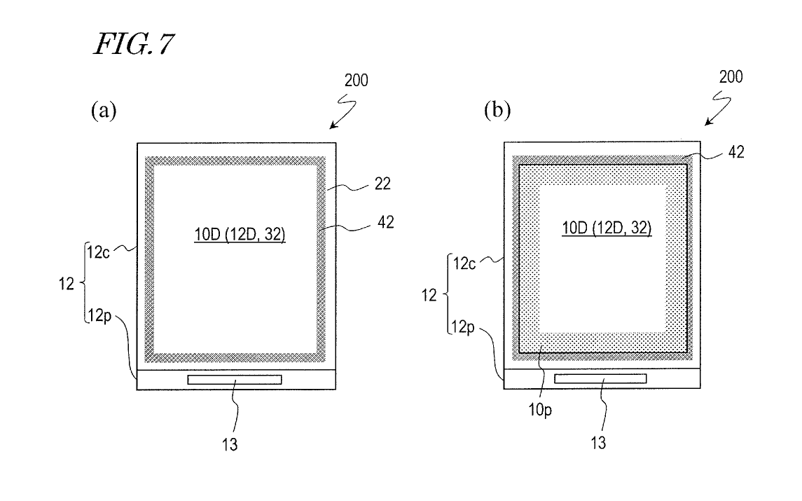

The case where a sealing material is contaminated with grease in a step of drawing a seal pattern will be described with reference to FIG. 5.

FIG. 5 illustrates infrared reflection-absorption spectra of a cured grease-contaminated sealing material (NG), a good cured state (OK) free from an impurity, and grease (impurity) with which a sealing material is contaminated.

A comparison of the infrared reflection-absorption spectra illustrated in FIG. 5 reveals that absorption peaks assigned to the C—H stretching vibration and so forth originating from the grease are increased in the NG absorption spectrum. The agreement rate of the NG absorption spectrum was 68%. Note that a determination as to whether a sealing material is contaminated with an impurity may be performed before curing the sealing material. It is difficult to rework after curing the sealing material, whereas reworking may be easily accomplished before curing the sealing material.

As described above, according to an embodiment of the present invention, it is possible to nondestructively and rapidly determine the quality of the cured state of a sealing material and the presence or absence of contamination with an impurity.

(a) to (c) of FIG. 6 are schematic plan views of liquid crystal display panels 100B, 100C, and 100D according to other embodiments of the present invention.

As with the liquid crystal display panel 100B illustrated in FIG. 6(a), metal layers 14b1 and 14b2 may be arranged at two points in the end region 12p of the TFT substrate 12, and additional sealing portions 44b1 and 44b2 configured to cover the metal layers 14b1 and 14b2 may be arranged. The additional sealing portions 44b1 and 44b2 are preferably arranged so as to be continuous with a sealing portion 42b. The metal layers 14b1 and 14b2 are preferably separated from lines and electrodes (including lines and electrodes in a terminal region 13b) included in the TFT substrate 12.

As with the liquid crystal display panel 100C illustrated in FIG. 6(b), metal layers 14c1, 14c2, and 14c3 may be arranged at three points in the end region 12p of the TFT substrate 12, and additional sealing portions 44c1, 44c2, and 44c3 configured to cover the metal layers 14c1, 14c2, and 14c3 may be arranged. The additional sealing portions 44c1, 44c2, and 44c3 are preferably arranged so as to be continuous with a sealing portion 42c. The metal layers 14c1, 14c2, and 14c3 are preferably separated from lines and electrodes (including lines and electrodes in a terminal region 13c) included in the TFT substrate 12.

As with the liquid crystal display panel 100D illustrated in FIG. 6(c), in the case where the TFT substrate 12 includes end regions 12p1 and 12p2 located along two sides that are orthogonal to each other, a metal layer 14d1 may be arranged in an end region 12p1, a metal layer 14d2 may be arranged in an end region 12p2, and additional sealing portions 44d1 and 44d2 configured to cover the metal layers 14d1 and 14d2 may be arranged. The additional sealing portions 44d1 and 44d2 are preferably arranged so as to be continuous with a sealing portion 42d. The metal layers 14d1 and 14d2 are preferably separated from lines and electrodes (including lines and electrodes in a terminal region 13d) included in the TFT substrate 12.

The liquid crystal display panel according to an embodiment of the present invention is not limited to those illustrated above. The present invention is applicable to various liquid crystal display panels. While the embodiments of the present invention have been described here by taking the liquid crystal display panels produced by the drop injection method as examples, the present invention is not limited thereto. The present invention is also applicable to liquid crystal display panels produced by a vacuum injection method and to other display panels.

### INDUSTRIAL APPLICABILITY

The present invention is applicable to the inspection of cured states of sealing materials in display panels, such as liquid crystal display panels, electrophoretic display panels, and organic EL display panels, and in production processes therefor.

### REFERENCE SIGNS LIST

10D display region

12 first substrate (TFT substrate)

12c facing region

12D pixel formation region

12p end region

13a terminal region

14a, 14b1, 14b2, 14c1, 14c2, 14c3, 14d1, 14d2 metal layer

22 second substrate (counter substrate)

32 display medium layer (liquid crystal layer)

42a, 42b, 42c, 42d sealing portion

44a, 44b1, 44b2, 44c1, 44c2, 44c3, 44d1, 44d2 additional sealing portion

100A, 100B, 100C, 100D, 200 liquid crystal display panel

1. A display panel comprising:
a first substrate including an end region and a pixel formation region;
a second substrate arranged so as to face the first substrate and expose the end region of the first substrate;
a display medium layer arranged between the first substrate and the second substrate;
a sealing portion configured to bond the first substrate to the second substrate and surround the pixel formation region; and
an additional sealing portion arranged in the end region of the first substrate, the additional sealing portion being composed of the same material as that of the sealing portion,
wherein the first substrate further includes a metal layer below the additional sealing portion.

2. The display panel according to claim 1, wherein the first substrate includes a plurality of lines and a plurality of electrodes, and the metal layer is separated from the plurality of lines and the plurality of electrodes.

3. The display panel according to claim 2, wherein the metal layer is composed of the same material as that of any of the plurality of lines and the plurality of electrodes.

4. The display panel according to claim 1, wherein the additional sealing portion is in direct contact with the metal layer.

5. The display panel according to claim 1, wherein the sealing portion is composed of an ultraviolet-curable acrylic resin.

6. A method of inspecting the cured state of a sealing material by Fourier transform infrared spectroscopy in a process for producing the display panel according to claim 1, the process including a step of forming the sealing portion and the additional sealing portion by curing the sealing material, the method comprising:
after the step of forming the sealing portion and the additional sealing portion, step a of acquiring the infrared reflection-absorption spectrum of the additional sealing portion from the second substrate side with the metal layer; and
step b of evaluating the cured state of the sealing material on the basis of the resulting infrared reflection-absorption spectrum of the additional sealing portion.

7. The method according to claim 6, wherein step b includes substep b1 of comparing the previously provided infrared reflection-absorption spectrum of the sealing material in a good cured state with the infrared reflection-absorption spectrum of the additional sealing portion.

8. The display panel according to claim 2, wherein the additional sealing portion is in direct contact with the metal layer.

9. The display panel according to claim 3, wherein the additional sealing portion is in direct contact with the metal layer.

10. The display panel according to claim 2, wherein the sealing portion is composed of an ultraviolet-curable acrylic resin.

11. The display panel according to claim 3, wherein the sealing portion is composed of an ultraviolet-curable acrylic resin.

12. The display panel according to claim 4, wherein the sealing portion is composed of an ultraviolet-curable acrylic resin.

13. A method of inspecting the cured state of a sealing material by Fourier transform infrared spectroscopy in a process for producing the display panel according to claim 2, the process including a step of forming the sealing portion and the additional sealing portion by curing the sealing material, the method comprising:
after the step of forming the sealing portion and the additional sealing portion, step a of acquiring the infrared reflection-absorption spectrum of the additional sealing portion from the second substrate side with the metal layer; and
step b of evaluating the cured state of the sealing material on the basis of the resulting infrared reflection-absorption spectrum of the additional sealing portion.

14. A method of inspecting the cured state of a sealing material by Fourier transform infrared spectroscopy in a process for producing the display panel according to claim 3, the process including a step of forming the sealing portion and the additional sealing portion by curing the sealing material, the method comprising:
after the step of forming the sealing portion and the additional sealing portion, step a of acquiring the infrared reflection-absorption spectrum of the additional sealing portion from the second substrate side with the metal layer; and
step b of evaluating the cured state of the sealing material on the basis of the resulting infrared reflection-absorption spectrum of the additional sealing portion.

15. A method of inspecting the cured state of a sealing material by Fourier transform infrared spectroscopy in a process for producing the display panel according to claim 4, the process including a step of forming the sealing portion and the additional sealing portion by curing the sealing material, the method comprising:
after the step of forming the sealing portion and the additional sealing portion, step a of acquiring the infrared reflection-absorption spectrum of the additional sealing portion from the second substrate side with the metal layer; and
step b of evaluating the cured state of the sealing material on the basis of the resulting infrared reflection-absorption spectrum of the additional sealing portion.

16. A method of inspecting the cured state of a sealing material by Fourier transform infrared spectroscopy in a process for producing the display panel according to claim 5, the process including a step of forming the sealing portion and the additional sealing portion by curing the sealing material, the method comprising:
after the step of forming the sealing portion and the additional sealing portion, step a of acquiring the infrared reflection-absorption spectrum of the additional sealing portion from the second substrate side with the metal layer; and
step b of evaluating the cured state of the sealing material on the basis of the resulting infrared reflection-absorption spectrum of the additional sealing portion.
